(19) United States
(12) Patent Application Publication
(10) Pub. No.: US 2009/0008468 A1
(43) Pub. Date: Jan. 8, 2009

(54) How to tame hurricanes and typhoons with available technology

(76) Inventor: Gordan I. Skukan, Long Beach, CA (US)

Correspondence Address: GORDAN SKUKAN, APT#1, 1500 E. 3RD ST, LONG BEACH, CA, 90802, US

(21) Appl. No.: 11/543,293

(22) Filed: Apr. 2, 2007

(51) Int. Cl. A01G 15/00

(52) U.S. Cl. 239/2.1; 239/14.1

(57) ABSTRACT

The hard fact of physics is that water on the surface of the ocean will not evaporate by significant amounts after being treated with the introduction of ample amounts of liquid air.

If you can keep a layer of air at less that +30° F. on the surface of the ocean the existing vapor will condensate before it reaches an elevation of one foot. This vapor will remain ‘trapped’ there as long as temperature conditions are maintained and the surrounding air does not warm significantly.

When significant amounts of liquid air are injected onto the ocean surface the subsequent temperature of the air will stay between −330° F. and +30° F. for eight to twenty hours.

Hurricanes and Typhoons events are in the same family of winds and storms. Typhoons get stronger because they are formed in the open waters of the Pacific Ocean, which is wider than the Atlantic Ocean, and therefore the Pacific Ocean typhoons have more time to become more devastating before reaching land.

Hurricanes and Typhoons have basic parts: the eye, the stem, and the dome.

The eye is the center element of the storm, it is calm, and consists of the smallest surface. (Occasionally hurricanes and typhoons have two eyes. These storms are generally harmless). The size of the eye can vary from a mile or two to over a hundred miles in length.

The stem is the windy, wet, and harmful cloud-filled area that surrounds the eye. In most cases the walls of the stem are very visible from the center of the eye.

The dome is the highly condensed area at the top of the storm that resembles the shape of a mushroom.

The Theory: In general, the storm is tamed by cooling the surface temperature of the waters in the eye by dispensing a mixture of ‘liquid air’ (Approximately three (3) parts Nitrogen (N₂) and one (1) part Oxygen (O₂). N₂ is known as gentle gas where as O₂ can be volatile under the right circumstances. In this application, both gasses should be handled as volatile due to the low temperatures achieved (around −300° F.) (It is important to mention that these gasses have different boiling points and have to be stored separately).

The Application: In the tropics the surface temperature of the ocean surface can be hot with an area of hot air rising above it. This moisture filled hot air rises following natural laws. As it ascends it passes through somewhat cold layers of air. When it reaches the cold region of the stratosphere the moisture contained in this once warm air condenses into a fog or cloud. Winds carry this moisture laden cloudy mass to even colder regions. When it reaches the dew point, rain begins.

The hurricane or typhoon is formed when the rising moisture laden air forms a low-pressure vacuum and the surrounding air moves in creating an increasing persistent wind. The incoming air is also warm and because of gravity forces the wind begins to rotate around the center and slowly looses pressure. At this point we have an eye. As this situation continues a sub-pressure condition that facilitates a stronger evaporation on the ocean surface a full-fledged storm is born. To prevent these storms from reaching land and causing devastation we can treat them.

The Treatment: Treatment starts by delivering liquid Nitrogen and Oxygen from a fleet of specially designed ships to the surface waters of the eye of the storm. The process resembles the effect one would see from theatrical fog machines. The N₂ and O₂ liquid gasses are carried to the eye under pressure, as it is dispensed it evaporates immediately and hugs the ocean surface cools and this in turn slows down the accumulation of moisture and velocity of the raising warm air. This fog of N₂ and O₂ spreads exactly like water poured on a hard floor, it does not build-up. Great amounts of are need to cover the ocean surface of the eye, wall to wall. The N₂—O₂ fog warms as it mingles with the hot surface air and has to be replenished.

The object of this procedure is to prevent the raising air from carrying with it the moisture that previously created and fed the storm. The environment is not being harmed. This cooling only temporally changes the temperature of the air and has no lasting effects on the environment outside of diminishing the intensity of the present hurricane or typhoon.

It takes one (1) gallon of liquid N₂—O₂ air to make one hundred (100) cubic feet of breathable air, so at 70° F. releasing one hundred (100) gallons of liquid air would be equivalent to ten-thousand (10,000) feet of cold air. Because of the temperature difference the warm air continues to travel upward in the eye while cool air remains on the surface trapping the moisture by reducing the amount of evaporation occurring. As this interaction continues, the area will start building the pressure inside the eye and consequently the pressure inside becomes closer to the pressure outside of the eye, and the winds will diminish.

The Ships: A minimum of three ships would be needed to deliver the liquid air to the eye of the storm. I propose converting military ships and carriers to hold a minimum of twenty (20) to thirty million (30,000,000) gallons each. The ships would have to have state of the art navigation and computer monitoring capabilities. The volatility of the super cold (300° F.) compressed liquid air is a major consideration. The compartments must be airtight, all pumps and electrical systems will have to be spark proof, and all of the air inside will have to be supplied from compression tanks. Only discharged air will be permissible.

The Rationale: Authorities are asking for at least a twenty-percent (20%) reduction of the devastation caused by the landing of hurricanes and typhoons to be considered viable. The proposed method can make from fifty (50%) to an eighty-percent (80%) reduction of the devastating force if given enough advance notice to attack the storm five hundred (500) miles off shore. We can end the devastation from storms like Katrina forever. All of this can be done with available technology.

The Cost: Katrina could have been significantly reduced for around fifteen million dollars ($15,000,000.00). One (1) gallon of liquid air can be processed for around thirty cents ($0.03). Using the Katrina example, approximately 50,000,00 gallons would have been needed. The major cost item would be the acquisition and conversion of the delivery fleet.

### Introduction:

IN THE EYE OF A HURRICANE, THE SURFACE OF THE OCEAN IS 80° F. OR MORE, IT IS A CALM, SUB-PRESSURE ENVIRONMENT THAT FACILITATES EASY, INVISIBLE, INTENSE EVAPORATION. THIS IS WHAT I CALL A “NON-TREATED HURRICANE”.

1. IF ONE COULD INTRODUCE A LAYER OF SUPER COLD (−330°) AIR ONTO THE SURFACE OF THE OCEAN INSIDE, THE EYE, OF A HURRICANE AND SUSTAIN IT FOR HOURS, PERHAPS DAYS. I MAINTAIN EVAPORATION WOULD BE SIGNIFICANTLY REDUCED. THIS IS WHAT I CALL A “TREATED HURRICANE”
WHILE THIS INCREDIBLY COLD AIR IS WARMING, THE SURFACE TEMPERATURE IS TAKING A SIGNIFICANT ‘DIP’. THE SURFACE TEMPERATURE WILL HAVE FALLEN FROM 80° F. TO 50° F., OR EVEN LOWER IF THE TREATING HAS BEEN ONGOING FOR 3 HOURS OR MORE.
EVEN IF THE LAYER OF SUPER COLD AIR IS NOT IDEALLY DISTRIBUTED, 50% COVERAGE WITHIN THE HURRICANE'S EYE, WOULD BE ENOUGH TO REDUCE THE EVAPORATION BY 30%.
I UNDERSTAND THIS THEORY MAY APPEAR TO BE GRANDIOSE, BUT IT IS BASED ON BASIC SCIENCE AND DESERVES THE OPPORTUNITY TO BE TESTED. THIS IS ESPECIALLY PERTINENT WHEN ONE CONSIDERS THE AMOUNT OF DEVASTATION HURRICANES WIELD. SAVINGS WOULD CERTAINLY OUT WEIGH THE COSTS OF THIS NOBLE EXPERIMENT.
